(19) United States
(12) Patent Application Publication
(10) Pub. No.: US 2010/0319633 A1
(43) Pub. Date: Dec. 23, 2010

(54) Adjustable male dog diaper wrap

(76) Inventor: Cynthia A. Moncheski, Florissant, MO (US)

Correspondence Address: Paul M. Denk, Suite 305, 763 S. New Ballas Road, St. Louis, MO, 63141, US

(21) Appl. No.: 12/803,266

(22) Filed: Jun. 23, 2010

Related U.S. Application Data
(60) Provisional application No. 61/269,338, filed on Jun. 23, 2009.

(51) Int. Cl. A01K 23/00

(52) U.S. Cl. 119/869

(57) ABSTRACT

An adjustable male dog diaper wrap with adjustable front chest strap which is used to securely hold in place, a disposable absorbent pad such as children's diaper or a feminine sanitary pad, in order to contain a male dogs bodily fluids from such conditions as territorial marking, incontinence, housebreaking and unplanned mating. The diaper wrap can also be used to contain a male dog's erected penis to form a barrier in the event of unplanned mating. The diaper wrap is comprised of one wide rectangular panel used to go around the circumference of the dog's penis and belly area and one long, narrow rectangular panel used to form the non-slip front chest strap. Other components of the diaper wrap include Velcro for securing the diaper wrap at the top of the dogs back and elastic which is secured in this panel, at the stomach area, to provide a snug and comfortable encasement of the absorbent insert in place as well as to contain the dog's penis in the event of unplanned mating. The front chest strap is equipped with a single side adjustable clasp to allow for variances in size and breed types. Fleece fabric is relative to usefulness of this invention.

### CROSS REFERENCE TO RELATED APPLICATION

This non provisional patent application claims priority to the provisional patent application having Ser. No. 61/269,338, having filing date Jun. 23, 2009.

### FIELD OF THE INVENTION

This invention relates to a secure adjustable male dog diaper wrap with adjustable non-slip front chest strap and sewn in moisture proof protective barrier.

### BACKGROUND OF THE INVENTION

This invention relates to a custom fitting male dog belly wrap in which the designed wrap secures and holds in place an absorbent pad in order to catch and contain urine or semen from a make dog thus providing a sanitary and livable environment for both the pet and pet owner without concern the wrap will slip off and thus become ineffective for its purpose. A secondary means of containment is built into the wrap by means of a sewn in layer of polyurethane laminate to prevent urine leakage beyond the inserted absorbent pad.

Canines are a different species than ours; they reproduce to ensure survival of their kind. Many owners choose not to neuter their dog. Nature is a strong force and a male dog is intent on getting to and impregnating a female dog in season. It is nature and it is natural. They breed and produce puppies that usually end up in animal shelters to be adopted or euthanized. Male dog urination and male dog marking are two distinctive conditions in regard to the quantity of the fluid eliminated. A large puddle is an indication the dog just had to urinate but circumstances did not accommodate getting outside. A large puddle can also be an indication of a medical condition such as incontinence. In the condition of a dog that is known to “mark”, several factors apply and are more commonly the more frustrating of the two. A marking dog leaves smaller amounts of urine and most often marks on upright objects such as furniture. They also tend to mark on new and unfamiliar items which may be brought into the home or his space. Marking dogs can also be one of multiple dogs living in the same house and who may regard each other a threat and therefore have more of a tendency to territorial marking. Even male dogs that are neutered are capable of territorial marking. These symptoms are also true of dogs who suffer from feelings of insecurity or who experience separation anxiety when left alone. Territorial marking is a form of confidence building in male dogs. Marking also defines a dog's social order and can be a signal he is available for mating. Other factors can result in a male dogs dribbling, urinating and marking such as age, physical condition and medical history. No one condition is any less frustrating for an owner when it involves an unplanned mating, urine damage to personal property, home or damage to property of others.

In the prior art there have are several introductions of diapers intended for the purpose of excrement containment. See, for example, U.S. Pat. No. 4,290,386, to Eiriksson (dog sanitary device); U.S. Pat. No. 4,996,949 to Uunderman (disposable dog diaper); U.S. Pat. No. 5,005,525 to Stanton (animal marking and urination control device); U.S. Pat. No. 334,252 to Stubbs (sanitary garment for animals); U.S. Pat. No. 5,226,386 to Thomas (absorbent urine detector for training animals): U.S. Pat. No. 383,259 to Post (diaper for male dogs); and U.S. Pat. No. 6,837,191 to Brewington (pet diaper garment).

While numerous dog diaper devices are intended for the same purpose as the present invention, all lack the design to provide a waterproof barrier or to provide a means of protection against unplanned mating. Various prior art show diapers using suspenders and harness' with multiple securing points and which wrap over, under and around chests, shoulders, front legs, back legs and tails. These demonstrate the disadvantages in practicality and simplicity in their ease of use. The prior art is not specific as to how the dog's excrement is kept from leaking through the diapers/wraps.

The objective of the present invention is to provide a secure adjustable male dog diaper wrap which includes a waterproof moisture barrier and an adjustable chest strap which, once set at a particular size, does not have to be re-adjusted for future use. Additionally, the present invention is specific in the materials and fabrics used in its construction as to allow for shrinkage, pet growth, wash and wear functions, cost effectiveness, and most importantly, comfort for the pet and ease of use for all pet owners regardless of age, and or physical and mental abilities.

### SUMMARY OF THE INVENTION

This invention relates to and contemplates the formation of an adjustable male dog diaper wrap, that once applied, is very secure, but includes various adjustable and non-slip front chest strap to provide for the stable mounting of the wrap to the animal. The entire unit is formed and sewn in a moisture proof protective barrier, for sanitation and cleanliness purposes.

The invention is a custom fitting dog male belly wrap, which wraps around the belly of the dog, and is designed as a wrap that secure and holds in place an absorbent pad in order to catch and contain any urine or semen from the male dog that provides a sanitary and livable environment for both the pet, and obviously the pet owner, without concern that the wrap will slip off and thus become ineffective for its intended purposes. A secondary means of containing is built into the wrap by means of sewn in layer of polyurethane laminate, to prevent urine leakage beyond the inserted absorbent pad.

It is, therefore, an object of this invention, to provide an adjustable type of diaper wrap that can be secured around the dog, and which may include adjustable features, so as to allow its application to various dogs of different sizes, during usage.

Another object of this invention is to provide a wrap that is secured by strapping at various locations, to sustain its securement in place, once applied.

These and other objects may become more apparent to those skilled in the art upon review of the summary of the invention as provided herein, and upon undertake a study of the description its preferred embodiment, in view of the drawings.

### DESCRIPTION OF THE DRAWINGS

FIG. 1 is a perspective view of a dog shown wearing a diaper garment according to an embodiment of the invention.

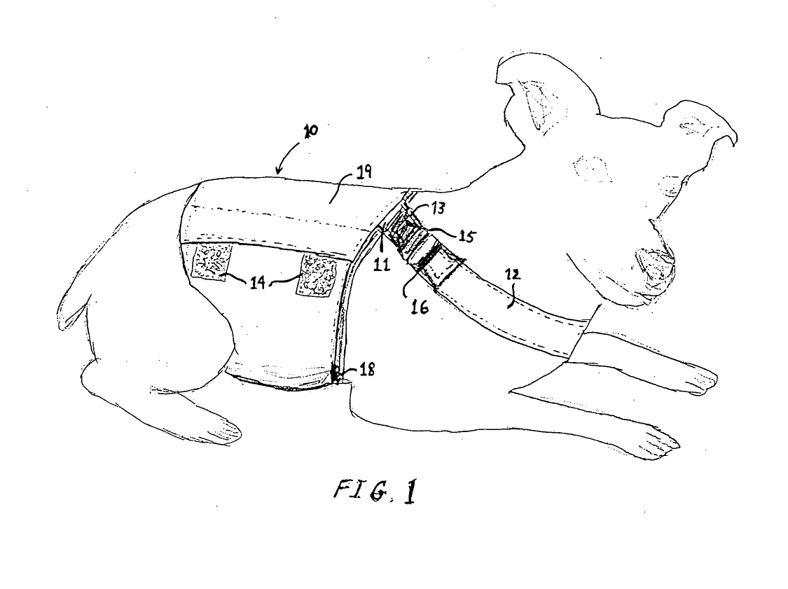

FIG. 2 is a perspective view of an embodiment of the diaper garment of the invention; and

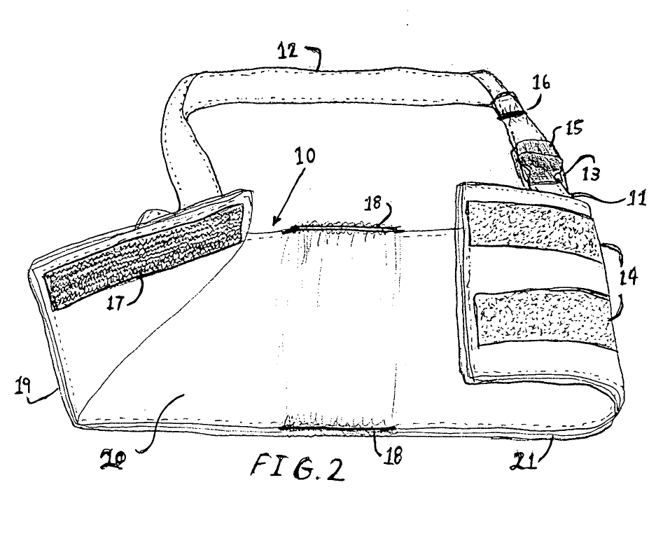

FIG. 3 is a perspective view of an embodiment of the diaper garment of the invention, showing component parts of this invention.

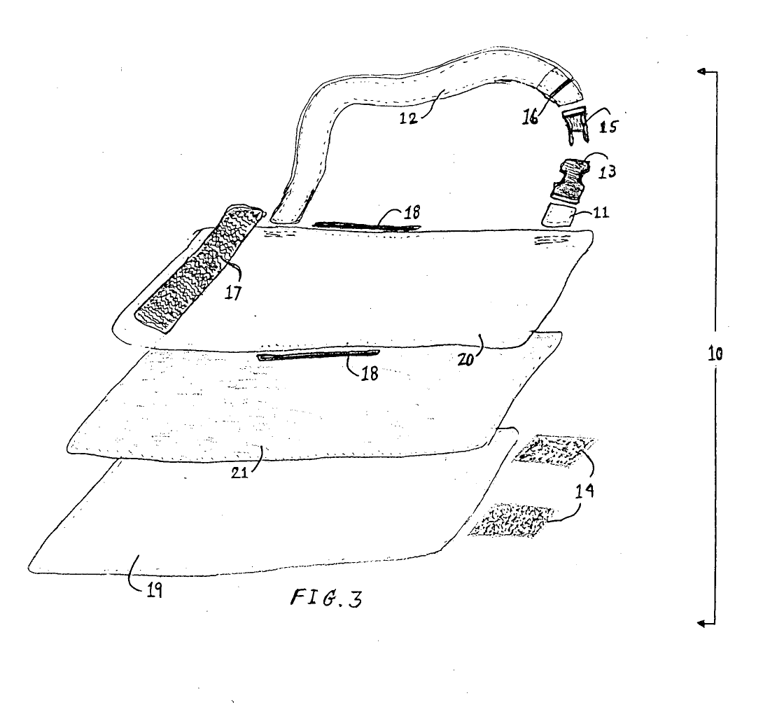

### DESCRIPTION OF THE PREFERRED EMBODIMENT

As shown in FIG's 1, 2, and 3, the diaper wrap of this invention generally comprises three layers of fabric denominated as 20, 21 and 19 which encircles the back, stomach and penis area of the pet. The invention of this diaper wrap is secured at the upper back of the pet with Velcro as denominated as 14 and 17. In order to keep the invention from sliding off the dog, an adjustable chest strap as denominated as 11 and 12 and is secured to both sides of the diaper wrap by an adjustable clasp as denominated as 13 and 15. Any excess strap fabric which may occur from adjusting to a much smaller size is secured in place by an elastic loop slid. The strap is denominated as 16. In order to contain and secure any secretion from the pet as well as to hold any choice of absorbent pads in place, one-forth inch wide elastic is sewn into the underside center of the dog wrap as denominated as 18. This is also the means by which to contain and encompass the male dogs erected penis and ejaculated semen in order to provide the secure barrier needed to prevent unwanted mating.

Finished embodiment 10 will be adjustable from within a four inch size variance around the belly and has an adjustable chest strap 11, 12, 13, 15, 16. It is slightly elasticized 18, in the center of embodiment 10, 19, 20, 21, to allow for a snug fit and containment of secreted pet fluids and male pet genitals.

To assemble, fold the long strap segment 12, in half lengthwise and it is sewn all around, approximately one-fourth inch from the edge. Fold short strap segment 11, in half lengthwise and is sewn all around, approximately one-fourth inch from edge. Feed sewn short strap segment, through female end of clasp 13. Fold inner fabric layer segment 20, in half. From fold of inner segment 20, measure and mark two inches at edges on both sides. This will be the marks used to stretch the pre-cut four inch elastic 18, in center inner of inner segment 20 and embodiment. Starting at the first mark and placed approximately one-fourth inch in from edge of segment 20 sew the elastic 18 stretching the elastic 18 slightly as it is fed through the machine. Stop at other marking. Do the same on the other side of the segment 20. Position the waterproof barrier fabric 21, to elastic 18 sewn side of inner segment 20. Place the outer segment 19 next to the waterproof barrier segment 21 as if to create layered segments 19, 21, 20, thereby enclosing waterproof barrier segment 21 in between the inner and outer segments 19, 20. Starting at all the corners, pin the inner segment 20, waterproof barrier segment 21 and outer segment 19 together, stopping when reaching the elastic 18. Lay lined up segments 19, 21, 20 on table with the elastic 18 sewn segment 20 facing up. This will be the segment 20 that physically comes in contact with the dog's body on the completed embodiment 10. While laid out, measure two inches down from corner edge on one side of embodiment and then the other side of the embodiment. These will be the placement marks for sewing in the adjustable strap segments 11, 12 in place. Place long strap piece 12 at the markings on left side of embodiment. Make sure the raw edge of strap 12 is toward the elastic 18. Place the short strap 11 with female clasp 13 at markings on right side of embodiment. Make sure the raw edge of strap 13 is toward the elastic 18. Begin to sew all layers segments 19, 21,20, 12,11 together. Reinforce the seam where the strap segments 12,11, are placed by going back and forth with machine. When approaching the elastic 18 on embodiment, stretch elastic 18 again while it is feeding through machine. This will allow all segments 19, 21, 20 of embodiment to have an elastic edge. The side of wrap with the long strap 12 attachment will be the left side of wrap and the short/clip 11,13 side of wrap will be the right side of wrap. Take the pre-cut hook piece of Velcro segment 17 and position horizontally to inside left side of embodiment. Try to get as close to edges as possible but still allowing the stitches to securely catch all layers of the embodiment. Double stitch. Trim, excess Velcro. Using one of the pre-cut loop Velcro segments 14, position vertically to the outside of the right side of embodiment. The width of the Velcro segment 14 should be as close to narrow edge of wrap as possible, however, lengthwise it should be positioned approximately one-forth inch from the long edge of embodiment. Follow same on other side. Using a pre-cut one fourth inch segment of elastic 16, sew a loop as wide as the finished segment 12. Slide the completed loop 16. The preferred fabric selection for inner, outer and strap segments 19, 20, 12,13, of this invention is fleece fabric. The fleece is soft, extremely light weight, dries quickly and withstands frequent washings and drying. The fabric choice for the water proof barrier segment 21 would consist of a high density polyethylene fabric which can be washed and dried without damage to the performance and expectation of dryness. While the invention has been described with various layered segments, the invention can also be constructed without the waterproof barrier segment 21, leaving it an embodiment of two fabric segments 19, 20 as to allow for more comfort in warmer climate situations.

Variations or modifications to the subject matter of this invention may occur to those skilled in the art upon review of the disclosure as provided herein. Such variations, if within the spirit of this development, are intended to be encompassed within the scope of any claims to this invention. The review of the invention, as set forth in the description of the preferred embodiment, and as depicted in the drawings, are set forth for illustrative purposes only.

1. (canceled)

2. (canceled)

3. (canceled)

4. (canceled)

5. (canceled)

6. An adjustable male dog diaper wrap for application to and around the belly of a dog, said diaper wrap comprising a series of laminated layers applied together to form an absorbent pad, the first inner layer of said pad being of absorbent material, the middle layer of said pad resistant to leakage, while the outer layer provides an attractive cover for the diaper wrap, an elastic strip provided at the frontal edge of the wrap, to provide for its tightening against the lower belly of the dog when the wrap is applied, the wrap having fastening means provided at its edges, to provide for securement of the diaper wrap about the dog when applied, an adjustable front chest strap connecting to the upper front edges of the wrap, and provided for securing around the chest of the dog, to hold the diaper wrap in place during application.

7. The diaper wrap of claim 6 and including fastening means provided within the chest strap to facilitate its application and removal of the wrap from the dog when used.

8. The diaper wrap of claim 7 wherein said fastening means comprises a self locking adjustable clasp to accommodate a range of sizes and comfort level for the dog to witch the diaper wrap is applied.

9. The diaper wrap of claim 7 wherein said fastening means for holding the wrap in place about the dog is arranged laterally of the said wrap.

10. The diaper wrap of claim 9 wherein said fastening means comprises a hook and pile fastening means.
